(19) United States
(12) Patent Application Publication
(10) Pub. No.: US 2007/0260440 A1
(43) Pub. Date: Nov. 8, 2007

(54) Method, an Installation, and a Computer Program for Estimating the Initial Size of a Population of Nucleic Acids, in Particular by Pcr

(76) Inventors: Karline Piot, Montpellier (FR); Pierre Martineau, St. Gely Du Fesc (FR); Clair Lamoure, Viroflay (FR); Franck Molina, Les Matelles (FR)

Correspondence Address: NIXON & VANDERHYE, PC, 901 NORTH GLEBE ROAD, 11TH FLOOR, ARLINGTON, VA, 22203, US

(21) Appl. No.: 10/574,581

(22) PCT Filed: Nov. 18, 2005
(86) PCT No.: PCT/EP05/13021

§ 371 Date: Nov. 22, 2006

Related U.S. Application Data
(63) Continuation of application No. 10/998,175, filed on Nov. 29, 2004.

(30) Foreign Application Priority Data
Nov. 24, 2004 (FR) 0412471
Nov. 24, 2004 (FR) FR 04 12471

(51) Int. Cl. G06F 19/00

(52) U.S. Cl. 703/11

(57) ABSTRACT

In order to estimate the size of an initial population of nucleic acids in a sample of interests, in particular by PCR, the following steps are performed: (a) providing a model of the effectiveness of the PCR, the model comprising a constant stage followed by a non-constant stage, the stages being united by a changeover region having a changeover index; (b) using the model of effectiveness to express a relationship between the changeover index and a parameter representative of the initial population size; and (c) determining the changeover index by comparison with the experimental measurements, and deducing therefrom the initial population size in the sample of interest.

The present invention relates to estimating the initial size of a population of interest in a sample subjected to a succession of amplification reactions.

### BACKGROUND OF THE INVENTION

The present invention finds a particularly advantageous, but non-limiting, application in determining an initial quantity of nucleic acids in a sample subjected to a polymerase chain reaction (PCR) in real time. A technique of this type, known as “PCR quantification”, is used in particular for evaluating the number of copies of pathogenic agents (e.g. of the human immunodeficiency virus (HIV)) in a sample of body fluids taken from a patient, typically in the context of a medical checkup.

Reference is made to FIG. 1 for a brief description of the diagrammatic appearance of a real time PCR amplification curve with PCR cycle index numbers plotted along the abscissa and, in the example shown, with quantities of fluorescence emitted (in arbitrary units) as measured for each PCR cycle plotted up the ordinate. For each PCR cycle, it should be understood that the sample is subjected to temperature variations enabling DNA polymerase to amplify nucleic acids and enabling the corresponding PCR products to be detected by fluorescent molecules. By plotting the measured fluorescence Fₙ as a function of PCR cycle number n, variation is obtained of the type shown in FIG. 1, and comprises at least:
a first portion BN where fluorescence measurements coincide substantially with the background noise of the apparatus for measuring fluorescence;
a second portion EXP in which the measured quantities of fluorescence increase in substantially exponential manner;
a third portion LIN in which the increase in the measured quantities of fluorescence is significantly attenuated and behaves overall in substantially linear manner; and
a fourth portion PLA in which fluorescence measurements reach a plateau stage.

It should be observed that for the initial PCR cycles (first and second portions), the population of interest increases in substantially exponential manner, whereas for the following cycles (third and fourth portions), other phenomena come into competition with growth in the population of interest, so that said growth is then damped up to the plateau stage PLA.

The document “Mathematics of quantitative kinetic PCR and the application of standard curves” by R. G. Rutledge and C. Côté, published in Nucleic Acids Research, 2003, Vol. 31, No. 16, discloses a method of estimating the unknown initial quantity of nucleic acids in a sample of interest by means of PCR. That method consists in using a plurality of samples having known initial quantities of nucleic acids, referred to as “standards”, in order to determine by interpolation the initial quantity of nucleic acids present in the sample of interest.

In general, the greater the initial quantity of nucleic acids in a sample, the sooner a detectable quantity of PCR product is obtained, i.e. the sooner a detectable quantity of emitted fluorescence is obtained. With reference to FIG. 2, relating to the prior art, it will be understood that the initial population in the standard St1 is greater than that in the standard St2 which is greater than that in the standard St3, etc., since the cycle Ct1 for the standard St1 occurs before the corresponding cycle Ct2 for the standard St2, which occurs before the cycle Ct3 for the standard St3, etc.

Thus, such a CT cycle, corresponding to the cycle at which the fluorescence measurements reach a fluorescence threshold THR (as shown in FIG. 2), sets at an arbitrary level (typically below the background noise), and acts as a parameter representative of the initial size N₀ of a population of nucleic acids subjected to the PCR cycles. Use has been made of this observation in the above-cited prior art to establish a relationship of the kind shown in FIG. 3 between cycle numbers Ct1, Ct2, Ct3, Ct4 for a plurality of standards having known initial populations, and their initial populations N₀¹, N₀², N₀³, N₀⁴. Thus, by plotting the cycles Ct1, Ct2, Ct3, Ct4, etc. up the ordinates and the logarithm of the initial population sizes N₀¹, N₀², N₀³ N₀⁴ along the abscissa, a regression slope REG is obtained. On this regression slope PEG, the cycle Ctint detected for the sample of interest is plotted (dashed-line arrow F-1). By interpolation on the regression slope REG (dashed-line arrow F2), the initial population size N₀^{int} is then determined for the sample of interest.

Although that method is in widespread use, it nevertheless presents some drawbacks.

Firstly, it requires the use of a plurality of standard samples having respective known initial populations.

Secondly, the method depends on the judgment of the user, since the fluorescence threshold value, as selected by the user, has a direct influence on the values of the Ct cycles in the amplification curves, and consequently on the estimated values for the initial population size in the sample of interest. The threshold value also has an impact on the accuracy of the result, since accuracy is generally better if the threshold is selected to lie in the exponential growth stage EXP of the amplification curve. Nevertheless, in practice, it is difficult for the user to know whether the fluorescence threshold level THR that has been set does indeed correspond to the exponential stage of the curves, and does so for all of the samples (the standard samples and the sample of interest).

Finally, the method assumes without any verification that the population has the same amplification yield in the sample of interest and in all of the standard samples. Thus, if the sample of interest contains PCR inhibitors, as is typically the case, then its result will be falsely lowered.

It should thus be understood that the prior art technique depends on the fluorescence threshold THR as defined by the user. The value selected has an influence on the values of the Ct cycles and consequently on determining the initial quantity in the sample of interest. That is one of the reasons why a large amount of work has recently been undertaken to automate Ct cycle detection and make it reliable.

### OBJECTS AND SUMMARY OF THE INVENTION

The present invention seeks to improve the situate on by proposing an approach that is completely different.

Firstly, the invention provides a method, the method being implemented by computer means for quantifying in absolute and/or relative manner an initial population of nucleic acids in a sample of interest. The sample is subjected to a succession of applications of a reaction for amplifying the population of interest. In very general manner, this amplification may be undertaken by implementing successive PCR cycles, however any other amplification technique could also be used. Above all, it should be understood that the amplification needs merely to be defined by a reaction yield, as described below. During these successive amplification operations, experimental measurements are taken that are representative of a current population size, at least in the sample of interest. It will be understood that one or more measurements can be taken after or during each amplification reaction without loss of generality.

In a presently preferred definition of the invention, the method in the meaning of the invention comprises the following steps:

a) providing a model of the yield of the amplification reaction as a function of the succession of amplifications, said model comprising:
a substantially constant stage for a first portion of the applications of the amplification reaction; and
a non-constant stage for a second portion of the applications of the amplification reaction;

the first and second portions being united by a changeover region in which yield changes over between the constant and non-constant stages, said region having an amplification index corresponding substantially to the changeover;

b) using the yield model to express a relationship involving at least the changeover index and a parameter representative of the initial population size in the sample of interest;

c) determining at least the changeover index by comparison with the experimental measurements; and, in a subsequent or immediately following step d) deducing therefrom the initial population size in the sample of interest.

### BRIEF DESCRIPTION OF THE DRAWINGS

Other advantages and characteristics of the invention appear on reading the following detailed description of an implementation given below by way of example with reference to the accompanying figures, in which:

FIG. 1 relates to the prior art and represents variation in the measured quantity of fluorescence as a function of the number of PCR cycles, as described above;

FIG. 2 relates to the prior art and is representative of the increasing quantities of fluorescence that are emitted as a function of the number of PCR cycles, as described above;

FIG. 3 represents an interpolation method for determining the initial quantity of the population of interest in the sample of interest using a method known in the prior art, and described above;

FIG. 4A is a diagram showing variation in the above-described experimental measurements as a function of the succession of amplifications applied to the sample of interest;

FIG. 4B is a diagram showing variation in the yield of the amplification reaction, obtained from experimental measurements, as a function of the succession of amplifications applied to the sample of interest;

FIG. 5 plots a regression relationship between the yield changeover indices that occur at the changeover between the constant stage and the non-constant stage, and the logarithms of the initial populations for standard samples and for the sample of interest, for use in a first implementation;

FIG. 6A shows typical variation in the measured quantity of fluorescence after it has been adjusted by taking account of background noise specific to the measurements, and plotted as a function of the number n of PCR reaction cycles;

FIG. 6B shows the variation in the effectiveness of the PCR shown in FIG. 6A as a function of the number n of cycles;

FIG. 7 compares the experimental variation in emitted fluorescence as shown in FIG. 6A with the results obtained by applying the emitted fluorescence model obtained by including an effectiveness model in a second implementation;

FIG. 8 is a comparison between the variation in the effectiveness of FIG. 6B and the application of an effectiveness model deduced from the emitted fluorescence model of FIG. 7;

FIG. 9 is a flow chart outlining the main steps in the method in a proposed implementation of the present invention; and

FIG. 10 is a diagram of an installation for quantifying the initial population of a sample of interest.

### MORE DETAILED DESCRIPTION

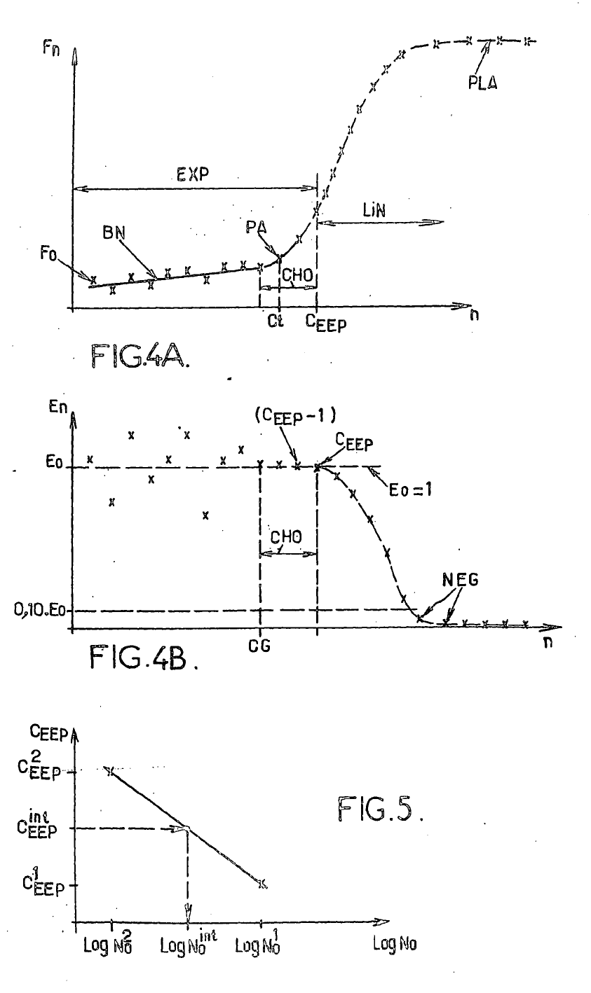

Reference is made to FIGS. 4A and 4B for briefly describing a few principles of the invention illustrating the characteristics of the above method.

Firstly, it should be understood that FIG. 4A plots a succession of experimental measurements Fₙ representative of the current size of a population of interest which is being subjected progressively to a succession of amplification reactions, each reaction being indexed by an index number n. In the non-limiting example described herein, this succession of reactions corresponds to a succession of PCR cycles. In this non-limiting example, the experimental measurements Fₙ correspond to measured quantities of fluorescence on each PCR cycle. Thus, in a quantification method which combines the PCR reaction and the fluorescence emitted by the sample of interest, fluorescent reagents are introduced into the sample so that the fluorescence that is emitted during a PCR cycle is proportional to the size of the nucleic acid population in the sample. Indeed, it can be preferable to perform a plurality of measurements or no measurements at all for certain PCR cycles. Furthermore, more generally, the measurement method may make use of techniques other than fluorescence, even if fluorescence is the method that is often used for quantifying by PCR. Finally, it should be understood that other amplification techniques could be implemented in the context of the present invention, providing it is possible to track variation in the yield of the reaction corresponding to the amplification. Since the example described below relates preferentially to PCR cycles, reference is made to the “effectiveness of the PCR” written Eₙ for each PCR cycle of index n, in order to refer to the yield of the amplification reaction.

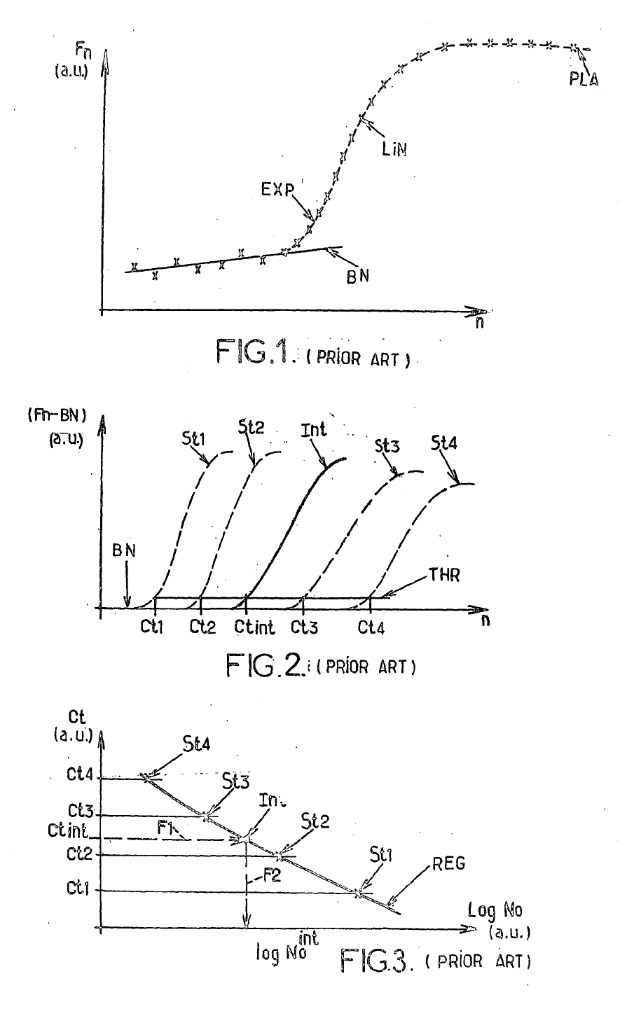

As mentioned above with reference to FIG. 1, FIG. 4A mainly comprises two regions in which:
during the initial PCR cycles (portion EXP), the population increases substantially exponentially; whereas
during the following cycles (the LIN and PLA portions), other phenomena come into competition with growth of the population of interest, so the growth becomes damped.

The following two assumptions are made:
the yield of the reaction Eₙ is relatively constant during the initial cycles over the portion EXP; and
after some number of cycles have been performed, the yield Eₙ of the reaction starts to decrease over the portions LIN and PLA.

This decrease in yield may have a variety of explanations, in particular a degradation and/or a lack of PCR reagents (DNA polymerase, dNTPs, primers, etc.) and/or inhibition by the products that are made themselves.

It is assumed herein that the yield is initially constant and that it subsequently decreases. Nevertheless, it should be understood that the invention applies more generally to the context of yield:
that is initially constant, which corresponds to a normal situation for growth by amplification; and
that is subsequently not constant (decreases or increases) which corresponds to a situation that is substantially abnormal.

In the context of reactions for amplifying the quantity of nucleic acids, it has been found that the yield often changes over from a constant stage to a non-constant stage. In the meaning of the invention, advantage is taken of this observation to deduce therefrom the initial quantity of nucleic acids, as described below in detail. Initially, it is merely stated that the yield can also change over from a non-constant stage during early cycles to a subsequent constant stage. The present invention is equally applicable to such a circumstance. In general, it should therefore be understood that in the meaning of the invention, a changeover of yield between a constant stage and a non-constant stage is detected.

The objective is to find the initial size of the population that has been subjected to amplification. With reference to FIG. 4, it will be understood that the measurement F₀ representative of this initial population size, which coincides in practice with the measurement background noise BN, cannot be used on its own for determining directly the initial population size. In the prior art, attempts have been made to quantify this initial population size by making use of the exponential stage, i.e. a stage that occurs typically on exiting background noise. A threshold cycle Ct is then determined (corresponding to point PA for “prior art”) in FIG. 4A. As mentioned above, in this region measurements are often affected by noise and it is difficult to determine accurately a threshold cycle Ct representative of exiting background noise.

In a completely different approach, the present invention instead makes use of nearly all of the points of the amplification curve in order to determine accurately a region CHO where the yield changes over between a constant stage and non-constant stage, typically in present circumstances between the exponential stage EXP and the linear stage LIN. It will be understood that measurements are logically less affected by noise in this region CHO than in the background noise exit region since the region CHO occurs during later cycles. Furthermore, particularly because of the mathematical properties associated with yield, it is shown below that, most advantageously, the number of standards that need to be used for quantifying the initial size of the population of interest is smaller than the number of standards used in prior art quantification.

The relationship for associating the changeover region CHO with the initial size of the population of interest is briefly described below. The yield of an amplification reaction is given by:
Nₙ₊₁=Nₙ+Eₙ×Nₙ
in which:
Nₙ is the size of the population of interest after an amplification of index n in a succession of amplifications;
Nₙ₊₁ is the size of the population of interest after a following amplification, of index n+1, in the above-mentioned succession of amplifications; and
Eₙ is the yield of the amplification reaction of index n in the above-mentioned succession of amplifications.

Reformulating this relationship as a recurrence relationship, we obtain:
Nₙ₊₁=(1+Eₙ)(1+Eₙ₋₁)(1+Eₙ₋₂) . . . (1+E₀)N₀
where N₀ is the initial size of the population of interest. So long as the yield Eₙ is constant, it will be understood that the above relationship can be written more simply as follows:
Nₙ₊₁=N₀×(1+E₀)ⁿ⁺¹
where the index n+1 has not yet reached the changeover region CHO. While the yield is constant during the initial cycles, the following applies:
Eₙ=Eₙ₋₁=Eₙ₋₂= . . . =E₀
where E₀ is the value of the yield during the constant stage. Nevertheless, when the index n+1 moves into the changeover region CHO, the relationship becomes:
Nₙ₊₁=N₀×(1+E₀)^{C}_{EEP}×function(C_{EEP},n+1)
where:
(C_{EEP}−1) is the last index of the amplification reaction during which the yield is still constant (it will thus be understood that the index C_{EEP} itself represents the changeover index proper between the exponential stage and the linear stage); and
the term function(C_{EEP}, n+1) is a particular function characterizing the non-constant stage of the yield and that depends at least on the changeover index C_{EEP} and on the current amplification index n+1.

It can thus be seen how it is possible to associate the changeover index C_{EEP} and the initial size N₀ of the population of interest. At this stage it can be understood that steps a) and b) of the above-defined method have already been implemented.

A first implementation consists in determining the changeover index C_{EEP} experimentally and in correlating it with the initial size by regression by using a plurality of standard samples that are subjected to the same amplification treatment as the sample of interest. Under such circumstances, it will be understood that steps b) and c) of the above-defined method are merely interchanged since initially the changeover index C_{EEP} (step c)) is determined experimentally, and subsequently the relationship between the index C_{EEP} and the initial size N₀ (step b)) is determined in order to end up with the initial size N₀ (step d)).

Before describing all of these steps in detail in the meaning of the first implementation, a method is described for determining the index C_{EEP} on the basis of experimental measurements. In particular, it will be understood that this method of determining the index C_{EEP} experimentally can be applied to another implementation that is different from the above-mentioned first implementation.

Returning to the relationship between the effectiveness Eₙ of a given cycle n and the current size of the population of interest in the same cycle Nₙ and in a subsequent cycle Nₙ₊₁, the effectiveness of the amplification can be expressed as follows:
Eₙ=(Nₙ₊₁/Nₙ)−1

In certain circumstances, in particular when there is no need to take account of background noise BN in the measurements, it is possible to a first approximation to assume that the measurements are substantially proportional to the current size of the population of interest. Nevertheless, in practice, account will more often be taken of measurement drift, with corrected experimental measurements F′ₙ being determined on the basis of direct measurements Fₙ as shown in FIG. 4A.

A prior step of processing the experimental measurements Fₙ is preferably applied, this step consisting in subtracting the background noise BN and subsequently in introducing compensation to take account of a non-zero measurement ε representative of the initial population size. In the example shown in FIG. 4A, the variation in the background noise BN as a function of the index n can be represented by a linear function since tests have shown that a linear model is satisfactory for fluorescence measurements in PCR. Nevertheless, in certain circumstances it may be preferable to use an exponentially-varying model. In any event, a model is applied that complies best with variation in the background noise BN as given typically by the initial measurement points. Thereafter, the selected model for variation in background noise BN is subtracted from all of the experimental measurement values Fₙ. By applying this step, it will be understood that the theoretical fluorescence measurement F₀ is reduced to a measurement value of zero, corresponding to an initial population size N₀ of zero, which is not representative of physical reality. Consequently, it is advantageous to apply compensation for this correction as follows:
F′ₙ=Fₙ−BN+ε
where:
the term F′ₙ corresponds to a corrected measurement for a current index n;
the term Fₙ corresponds to the raw experimental measurement at said current index n;
the term BN corresponds to the value for the background noise as modeled for the current index n; and
ε is the corresponding compensation term which is assumed to be constant in the example being described and which directly represents the initial population size N₀.

Although these steps of correcting for background noise are very advantageous in determining the changeover index C_{EEP}, they may also be applied to any determination and quantification of the initial population size N₀ whenever background noise is likely to falsify measurement of said population size N₀. In this respect, these steps may constitute the subject matter of separate protection, where appropriate.

The corrected measurements F′ₙ as obtained in this way are advantageously proportional to the current population sizes Nₙ in the samples of interest, such that the yield Eₙ can now be expressed directly as a function of measurement values (corrected as described above), by the following relationship:
Eₙ=(F′ₙ₊₁/F′ₙ)−1

Thus, from the experimental measurements Fₙ of FIG. 4A, corrected measurements F′ₙ are obtained from which there is subsequently determined the variation in the effectiveness Eₙ as a function of the succession of indices n, as shown in FIG. 4B.

In short, the experimental measurements are expressed in the form of an experimental variation in the effectiveness Eₙ of the kind shown in FIG. 4B as a function of the succession of amplifications n. This provides an experimentally-determined variation for the yield comprising:
a perceptibly noisy first region for low amplification indices n (specifically prior to the cycle CG in the example of FIG. 4B); and
followed by a second region exhibiting less noise for higher amplification indices (at least after the changeover region CHO).

At least in the most usual circumstance of amplification by PCR and measurement by fluorescence, the non-constant stage of yield is decreasing and corresponds to said second region presenting little noise (as shown in FIG. 4B). Specifically for the purpose of eliminating measurement points that run the risk of falsifying results when selecting a model to apply to the variation in yield:
a crude value E₀ is estimated for the constant yield stage; and
particularly when searching for the changeover index C_{EEP}, at least some of the measurements in the less noisy second region are ignored for which the estimated yield is less than a threshold value, e.g. corresponding to some fraction of the constant stage E₀.

These points NEG (FIG. 4) that are eliminated are typically those that correspond to very high amplification indices n and that might no longer satisfy the model for effectiveness which is selected substantially around the changeover region CHO. By way of example, in order to eliminate them, an average is evaluated for the constant stage of yield E₀, typically for the initial indices n. Thereafter, a threshold value is selected that corresponds to a fraction of the average found for the constant stage E₀, e.g. 10%. Thereafter, starting from the highest indices n, all measurement points NEG of measured yield lower than or equal to said threshold value are eliminated. This step, which is most advantageous for detecting the index C_{EEP}, can nevertheless be applied to any determination based on yield Eₙ, and may constitute the subject matter of separate protection, where appropriate.

When yield presents a non-constant stage in which yield is decreasing and which follows a constant stage, as shown in FIG. 4B, the changeover region CHO is identified by working in the direction of decreasing index numbers n, starting from the less noisy second region, and by detecting a coarse index CG for which the yield passes a predetermined value. Thus, with reference to FIG. 4B, going in the direction of decreasing index numbers n so as to rise towards the changeover region CHO, the yield associated with each index number is evaluated. For the first measurement point of yield that is significantly greater than the above-mentioned predetermined value, it is considered that the above-mentioned coarse index CG has been detected and corresponds to the index of the measurement point.

As described below in a subsequent implementation, it is possible for each measurement point to model the variation in its yield as though said set point itself corresponds to the changeover index C_{EEP}. In that implementation, if the constant yield stage E₀ is estimated, and if the estimated value exceeds the above-mentioned predetermined value, then the point is considered as corresponding to the coarse index CG.

In general, a maximum yield has a value of 1 so it is possible to select the above-mentioned predetermined value as being equal to 1. Nevertheless, this can be varied, and, for example, provision can be made to set the predetermined value as corresponding to the mean yield E₀ as evaluated over the initial reaction cycles.

Thereafter, the estimate of the value of the amplification index C_{EEP} in the changeover region is refined, which value may advantageously be a fraction, by working in the direction of increasing amplification index numbers, starting from the coarse index CG, and by detecting an amplification index for which the yield is approximately equal to the above-mentioned predetermined value. Thus, referring again to FIG. 4B, in order to refine the search for the changeover index C_{EEP} after the coarse index CG has been determined, a search is made downwards starting from the coarse index CG and going in the direction of increasing index number n, in steps of a size smaller than one whole index, and the abscissa value is determined, e.g. by interpolation, at which the predetermined value is crossed. Typically, so long as the constant stage value remains greater than 1, the search is continued in the direction of increasing number n, and the index (C_{EEP}−1) preceding the changeover is determined as soon as the constant value E₀ is equal to or very close to 1. That is why it is appropriate to select a search step size corresponding to a fraction of the index, for example 10% of one cycle n.

In the above-mentioned first implementation, a plurality of standard samples are provided having respective known initial population sizes, and the succession of amplifications is applied thereto under substantially the same conditions as for the sample of interest. Their respective changeover indices are determined in accordance with above-described steps a), b), and c). In step d):
a dependency relationship is established between the initial population sizes of the standard samples N₀^{st} and their indices C_{EEP}^{st}; and
after determining the index C_{EEP} for the sample of interest, the initial size of the population of interest N₀ is determined by interpolation on that dependency relationship.

Thus, with reference to FIG. 5, a dependency relationship can be established between the changeover cycles C_{EEP}¹, C_{EEP}² of the standards and their initial concentrations N₀¹, N₀² (actually the logarithms thereof), e.g. by regression. By measuring the changeover index C_{EEP}^{int} for the sample of interest and by plotting its value on the regression slope of FIG. 5, the initial concentration N₀^{int} in the sample of interest is obtained by interpolation.

This first implementation is thus quite similar to that of the prior art described with reference to FIG. 3. Nevertheless, it should not be forgotten that the changeover index C_{EEP} on which this first implementation relies does not correspond in any way to the threshold cycle Ct of the prior art.

In an approach that is significantly different from this first implementation:
in step b), use is made of the yield model to express variation that is parameterized as a function of the succession of amplifications, said variation making use of at least one parameter representing the changeover index C_{EEP}; and
in step c), at least said parameter representing the changeover index C_{EEP} is determined by comparison with the experimental measurements.

In a second implementation, this parameterized variation is representative of the current population size Nₙ in the sample of interest.

Typically, this parameterized variation can be drawn from an expression of the type given above:
Nₙ₊₁=N₀×(1+E₀)^{C}_{EEP}×function(C_{EEP},n+1)

Thus, in addition to a parameter representing the changeover index C_{EEP}, this variation makes use of a parameter representative of the initial population size N₀ in the sample of interest.

Thereafter, in steps c) and d) of this second implementation, these two parameters C_{EEP} and N₀ are determined substantially together.

Previously, in step a), it is necessary to determine a model for the above-mentioned function (C_{EEP}, n+1).

Usually, for PCR quantification, a model is selected for the non-constant stage of the yield corresponding to a decreasing exponential having a decrease parameter β which is described in greater detail below. This decrease parameter β is then determined in step c), at least with the changeover index C_{EEP}, by comparison with the experimental measurements.

Thus, in this second implementation, once the yield model Eₙ has been selected, it is applied to the general expression for the current population size Nₙ given by the above relationship. This provides a model for variation in the current population size Nₙ.

Nevertheless, unless the experimental measurements give the value for the current population size Nₙ directly (which is rarely true in practice at present), it is appropriate subsequently to model the experimental measurements Fₙ themselves, taking account of the subtracted background noise and the subsequent compensation ε as described above.

Thus, in a presently preferred implementation, the above-mentioned parameterized variation:
is representative of experimental measurements; and
includes a parameter corresponding to a measurement value F₀ representative of the initial population size.

Thereafter, the measured value of the initial population size F₀ is determined by comparing said parameterized variation Fₙ with the experimental measurements.

In order to perform this comparison, it is possible, for example, to adjust the parameters F₀, E₀, C_{EEP} and the decrease parameter β in the model of the measurements Fₙ by using statistical correlations (typically the least squares method) applied to the raw experimental measurements. An example implementation is described in detail below.

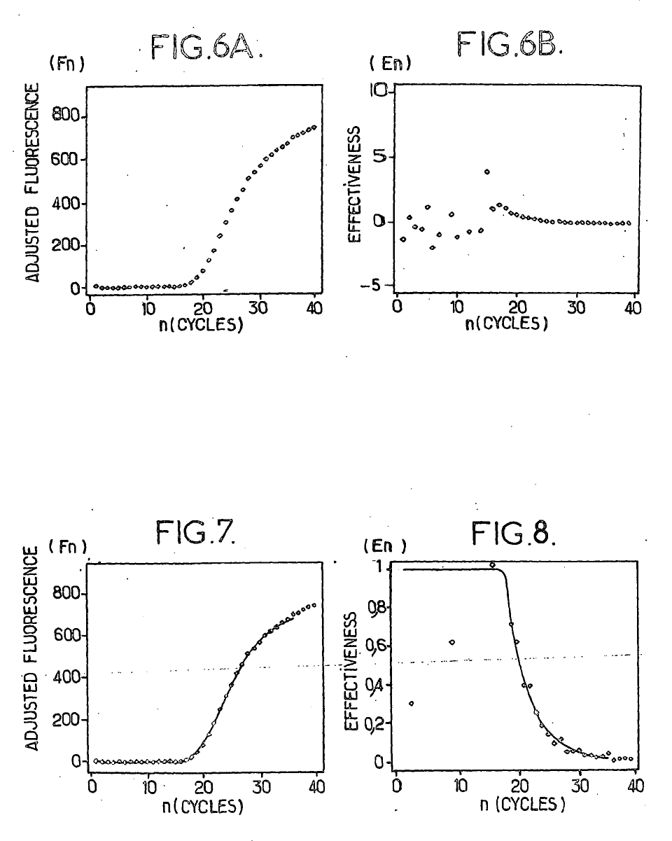

Initially, variation is obtained for the measured and adjusted quantity of fluorescence as a function of the number of PCR cycles that have been applied, as shown for example in FIG. 6A. This figure shows the amplification curve for a sample of interest containing nucleic acids, in this case a fragment of DNA having an initial quantity of 100,000 copies, marked by the SYBRGREEN intercalant during the PCR reaction which is performed on the I-Cycler IQ® apparatus from the supplier BI-RAD®.

In the example described, it will be understood that the amplification reaction is a PCR reaction in real time. The experimental measurement represents quantities of emitted fluorescence.

The fluorescence of cycle n after adjustment for background noise, as described above, is written Fₙ below. The theoretical initial fluorescence before the first cycle is written F₀. The effectiveness of the PCR in cycle n is written Eₙ. The total number of cycles performed during the PCR reaction is written N.

By assumption, the fluorescence measured on each cycle n of the PCR reaction cycle is defined by:
Fₙ₊₁≈Fₙ(1+Eₙ) for all nε{0, 1, 2, . . . , N−1} (1)
with 0≦Eₙ≦1.

The effectiveness of the reaction on each cycle n is calculated as follows:

$${E}_{n} = \frac{{N}_{n + 1}}{{N}_{n}} - 1 \approx \frac{{F}_{n + 1}}{{F}_{n}} - 1 for all n ∈ \{ 0 , 1 , 2 , … , N - 1 \} \qquad ( 2 )$$

It should be observed that equation (1) is assumed to be true for n=0. Nevertheless, by definition, the initial fluorescence F₀ is unknown. It is therefore not possible to calculate the effectiveness on the first cycle E₀ directly for formula (2)

FIG. 6B shows the effectiveness of the PCR reaction as approximated by formula (2) and on the basis of the adjusted variation in fluorescence of FIG. 6A, as a function of cycle number n.

The following assumptions are preferably made:
the effectiveness of the reaction is relatively constant during the initial cycles; and
after a certain number of cycles have been performed, the effectiveness of the reaction decreases.

FIG. 6B confirms the second assumption since it can be seen that effectiveness decreases as from cycle n=17. However, the measured effectivenesses in cycles 1 to 16 are very noisy, which makes it difficult to verify the first assumption graphically.

Nevertheless, it is preferable to assume that variation in effectiveness obeys a model of the type including:
a first stage that is constant between the first PCR cycle and the cycle (C_{EEP}−1) preceding the changeover cycle written C_{EEP}; and
a second stage in which it decreases for cycles of numbers greater than or equal to cycle (C_{EEP}−1).

The cycle (C_{EEP}−1) thus represents the last cycle (which may be a fraction) for which effectiveness continues to be constant.

It is then proposed to model the effectiveness of the reaction as follows:

$${E}_{n} = \{ \begin{matrix}{E}_{0} & for 0 \leq n \leq ( {C}_{EEP} - 1 ) \\ {( 1 + {E}_{0} )}^{exp ( - β ( n - {C}_{EEP} + 1 )} - 1 & \begin{matrix}for ( {C}_{EEP} - 1 ) \leq \\ n \leq ( N - 1 )\end{matrix}\end{matrix} \qquad ( 3 )$$

where E₀ and β are real parameters which are estimated using the amplification curve of FIG. 6A, or using the effectiveness curve of FIG. 6B in a manner described below.

In a variant, some other selection may be preferred, e.g. from the models F1 to F3 given below, particularly depending on the type of nucleic acid that is to be quantified.

F1: Eₙ=exp(−β(n−C_{EEP}+1))−1

F2: Eₙ=exp(−μ(n−C_{EEP}+1)^{α})−1

F3: Eₙ=α−exp(−μ(n−C_{nEP}+1)^{α})−1

Preferably, several sets of parameters are estimated in step c) for several candidate changeover cycles C_{EEP}, and the minimum candidate cycle is selected for which the associated parameters maximize the statistical correlations that can be undertaken in step c), for each changeover cycle C_{EEP}.

As mentioned above, expression (1) may also be written in the form:

$${F}_{n} = {F}_{0} {\prod }_{k = 0}^{n - 1} ( 1 + {E}_{k} ) for n ∈ \{ 1 , 2 , … , N \} \qquad ( 4 )$$

Thus, by introducing the expression (3) for effectiveness into formula (4), a new model is obtained having four parameters (F₀, E₀, β, C_{EEP}) for the adjusted emitted fluorescence Fₙ:

$${F}_{n} = \{ \begin{matrix}{{F}_{0} ( 1 + {E}_{0} )}^{n} & for 1 \leq n \leq {C}_{EEP} \\ {{F}_{0} ( 1 + {E}_{0} )}^{{C}_{EEP} + \frac{1 - exp ( - β ( n - {C}_{EEP} ) )}{exp ( β ) - 1}} & for {C}_{EEP} \leq n \leq N\end{matrix} \qquad ( 5 )$$

The initial size N₀ of the population of interest, the effectiveness E₀ of the reaction of n=0, the parameter β, and the changeover cycle C_{EEP} are evaluated repetitively for several cycle values in the vicinity of the changeover region CHO in order to find a statistical correlation maximum that is achieved for a minimum cycle value that is equal to the changeover cycle C_{EEP}.

In this second implementation, it is preferred to model variation in the measured and adjusted quantities of fluorescence as a function of cycle number on the basis of the models or variation in effectiveness, and subsequently to carry out the correlations directly on the measured and adjusted quantities of fluorescence.

It should be observed that by adjusting the measured emitted fluorescence for background noise, an artificial adjustment is also made on the initial fluorescence F₀. Thus, estimating the parameters of the effectiveness model on the basis of effectiveness measurements that are deduced from adjusted fluorescence measurements constitutes an additional source of error and it might be preferable to proceed in two stages as described below for the third implementation.

Nevertheless, the second implementation as described is simpler and adapts well to PCR quantification using fluorescence measurements. It is based on the real measurements of fluorescence F′ₙ which correspond to the fluorescence measurements adjusted for drift in background noise together with compensation ε on said measurements. Once the background noise has been subtracted, we have a relationship of the following type:
F′ₙ=Fₙ+ε
where ε is a quantity that may or may not depend on cycle number n. It is preferably selected to be constant.

Under such circumstances, the measured and “adjusted” effectiveness also written E′ₙ on cycle n is defined by:

$${E}_{n}^{′} = \frac{{F}_{n + 1}^{′}}{{F}_{n}^{′}} - 1 = \frac{{F}_{n + 1} + ɛ}{{F}_{n} + ɛ} - 1 for all n ∈ \{ 1 , 2 , … , N - 1 \} . \qquad ( 7 )$$

The model of above relationship (5) thus becomes:

$${F}_{n} = \{ \begin{matrix}{{F}_{0}^{′} ( 1 + {E}_{0}^{′} )}^{n} & for 1 \leq n \leq {C}_{EEP} \\ {{F}_{0}^{′} ( 1 + {E}_{0}^{′} )}^{{C}_{EEP} + \frac{1 - exp ( - {β}^{′} ( n - {C}_{EEP} ) )}{exp ( {β}^{′} ) - 1}} & for {C}_{EEP} \leq n \leq N\end{matrix} \qquad ( 8 )$$

Under such circumstances, the effectiveness values E′ₙ are approximated experimentally from the measurements so as to be able to set a minimum acceptable effectiveness threshold during the stage of decreasing effectiveness. A threshold cycle is thus determined beyond which the adjusted fluorescence measurements are not used for the purposes of the model (points NEG in FIG. 4B). Typically, the threshold cycle corresponds to the first cycle in the stage of decreasing effectiveness at which effectiveness drops below some minimum acceptable effectiveness threshold (e.g. 0.1 E₀).

More generally, the value of the effectiveness threshold preferably lies in the range 0 to 0.5, and PCR having an effectiveness value below said threshold is potentially biased by uncontrolled inhibition phenomena.

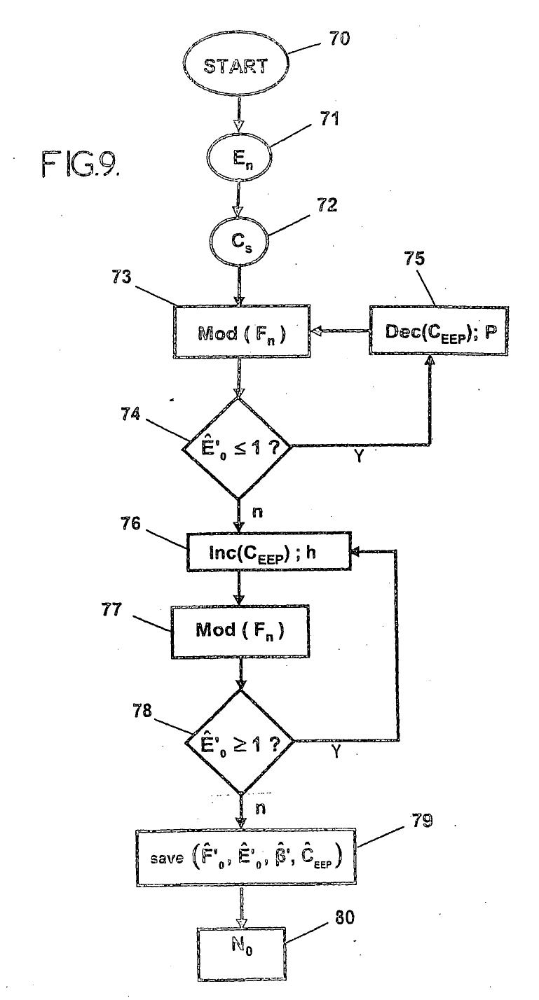

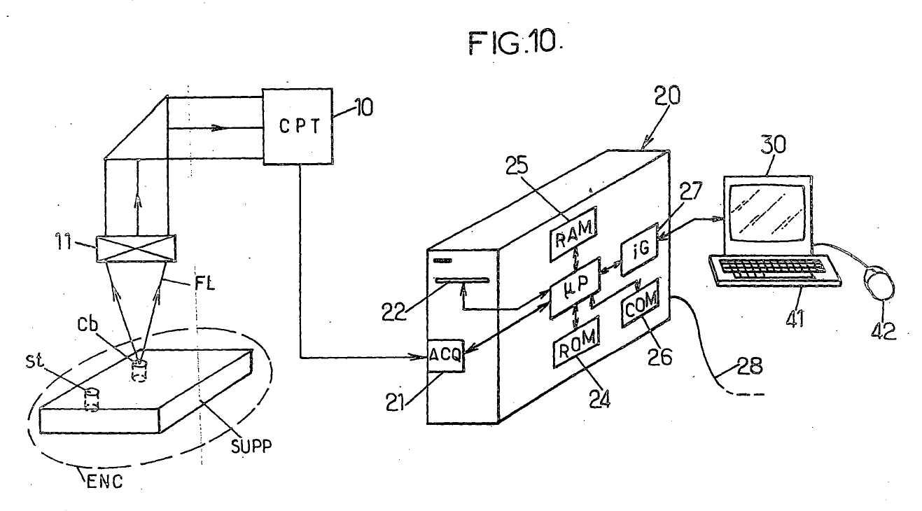

In the example shown in FIG. 7, the threshold value for effectiveness was set at 0.02 (i.e. 2% of E₀). The threshold cycle Cₛ corresponded to cycle n=36. FIG. 7 shows the adjusted measurements of emitted fluorescence. It can be seen that there is satisfactory correlation with the model (continuous line) for those experimental measurements (marked with an “o”) up to cycle n=36. FIG. 8 also shows good correlation with experimental measurements for predictive effectiveness as obtained from FIG. 7 using the model based on measured and adjusted fluorescence.

The main steps of this implementation can be summarized as follows, with reference to FIG. 9.

In a start step 70, the measured values for quantities of fluorescence have been obtained and adjusted relative to background noise as a function of cycle number n, as shown in FIG. 6A.

In step 71, an approximation for effectiveness of the reaction in cycle n is calculated using above formula (2) for each of the cycles n=1, 2, . . . , (N−1).

In step 72, the minimum cycle C₅ is determined for which the following two conditions are satisfied:
the cycle Cₛ lies in the stage of decreasing effectiveness; and
the effectiveness of the threshold cycle is less than the threshold effectiveness value Eₛ (e.g. Eₛ=0.1 E₀):
   E_{Cs}≦Eₛ

It is already possible to eliminate the points NEG for which effectiveness is less than Eₛ.

In step 73, a model is formed for the curve of adjusted emitted fluorescence which effectiveness is decreasing over the cycle range C_{EEP}=(Cₛ−5) to Cₛ, using expression (8) in which it is assumed that compensation ε is given by ε=F′₀:

$${F}_{n} = {{F}_{0}^{′} ( 1 + {E}_{0}^{′} )}^{{C}_{EEP} + \frac{1 - exp ( - β ( n - {C}_{EEP} ) )}{exp ( β ) - 1}} - {F}_{0}^{′}$$

Thereafter, test 74 on the value Ê′₀ estimated for the value E′₀ and the decrementation in step 75 of the value for the changeover cycle C_{EEP} seeks to find the looked-for value of C_{EEP} using a step size P (which may be equal to 1), and in repeating step 73 so long as the value of Ê′₀ is less than 1.

Thereafter, when the estimated effectiveness value exceeds the value 1 (arrow n on exiting the test 74), the value of the index C_{EEP} is incremented by a step of size h (which may be a fraction smaller than unity) in step 76 and in step 77 fluorescence Fₙ is modeled in the same manner as in step 73. So long as the estimated effectiveness Ê′₀ is greater than or equal to 1 in step 78, steps 76 to 78 are repeated. When the estimated effectiveness takes a value of less than 1, the estimated parameters (\hat{F}′₀,Ê′₀,\hat{β}′₀,Ĉ_{EEP}) are conserved in an end step 79.

In this step, a value \hat{F}′₀ has finally been obtained that alone is representative of the initial population size N₀ in the sample of interest. It is then possible to use at least one standard sample having a known population size N₀^{st} so as to determine in step 80 the initial population size N₀ in the sample of interest.

For this purpose, a measured value of an initial population size F₀ₛₜ in a standard sample of known initial population N₀ₛₜ is obtained. Thereafter, the value of the initial population size N₀ in the sample of interest is obtained by deriving a proportionality relationship between the measurement for the standard sample and its known initial population size, and applying that relationship to the measurement F′₀ to obtain the actual initial population size N₀.

In other words, in step 80 of FIG. 9, it is possible to determine the value N₀ of the initial population size in the sample of interest by applying a simple proportionality relationship of the type:
N₀=\hat{F}′₀(N₀ₛₜ/\hat{F}′₀ₛₜ)
implying that the initial population size in the standard N₀ₛₜ and the ratio of the corrected fluorescences as compensated and estimated by adjusting the fluorescence model apply both to the sample of interest and to the standard sample.

It will thus be understood that a single standard ought to be sufficient for determining the initial size of the population of interest in the sample of interest, which is an advantage provided by the invention.

Nevertheless, in a variant, and where necessary, provision could also be made to obtain respective measured values for initial population sizes \hat{F}′₀ₛₜ in a plurality of standard samples having known initial population sizes N₀ₛₜ. Thereafter, a dependency relationship is established between the initial population sizes N₀ₛₜ of the standard samples and the respective measured values for their initial population sizes \hat{F}′₀ₛₜ. Thereafter, after finding the measured value for the initial population size of the sample of interest \hat{F}′₀, the actual initial population size N₀ of interest is determined by interpolation using the dependency relationship. It will be understood that this dependency relationship may also typically be a regression of the type shown in FIG. 5, but having the initial fluorescence values \hat{F}′₀ₛₜ and \hat{F}′₀ of the standards and of the sample of interest plotted up the ordinate (or the values of their respective logarithms) instead of plotting values for the changeover index C_{EEP}.

Once use is made of one or more standards, provision can be made for one or more standard samples having respective known initial population sizes N₀ₛₜ to which the succession of amplification reactions is applied under substantially the same conditions as for the sample of interest. Thereafter, the measured values \hat{F}₀ₛₜ, for their initial population sizes are determined by making comparisons of the parameterized variations with the experimental measurements, as for the sample of interest.

In other words, the same calculations are naturally applied concerning the measured and adjusted quantities of fluorescence both on the standard(s) and on the sample of interest. The quantity of fluorescence \hat{F}′₀ₛₜ before the first cycle is estimated for the standard(s) using the same method as is used for determining \hat{F}′₀ for the sample of interest, as described above.

A third implementation, corresponding to a variant of the above-described second implementation consists overall in adjusting the model for the effectiveness Eₙ relative to the experimental measurements, and in subsequently injecting said adjusted effectiveness model into the model for the current population size Nₙ, or into the model for the measurement Fₙ. This third implementation can be summarized as follows.

The parameterized variation constructed in step b) is representative of yield, and in step c), experimental variation of the yield is determined on the basis of experimental measurements in order to compare the parameterized variations with the experimental variation. Thereafter, in order to obtain a parameter representative of the initial population size N₀ the following steps are performed in step d):

d1) determining a second parameterized variation representative of the current population size Nₙ in the sample of interest, making use at least of the parameter representing the changeover index C_{EEP}, and a parameter representative of the initial population size N₀;

d2) applying to said second variation, a parameterized value for the changeover index C_{EEP} as determined in step c); and

d3) adjusting at least the parameter representative of the initial population size N₀ by direct comparison off the second variation with the experimental measurements.

Advantageously the following are performed:
in step d2), applying a coarse value for the changeover index C_{EEP} in the same manner as described for detecting it with reference to above FIG. 4B; and
in step d3), subsequently refining the index value together with adjusting the parameter representative of the initial population size N₀.

Finally, it should be understood that the presently preferred second implementation of FIGS. 7 and 8 differs from this third implementation by the fact that no attempt is made to perform correlations on effectiveness, but use is made merely of the mathematical model for effectiveness variation in order to model and refine the estimate of the correct and compensated fluorescence.

Naturally, the present invention is not limited to the embodiments described above by way of example, and it extends to other variants.

Thus, it will be understood that the present invention can also apply to relative quantification, in particular by PCR. In this application, as well as amplifying the population of interest, a reference population is also amplified either simultaneously in the same medium, or separately. Measurements are taken as follows:
experimental measurements representative of the size of the population of interest; and
experimental measurements representative of the reference population size.

The method can then continue by applying steps a), b), and c) to the reference population while step d) consists merely in determining a ratio between the respective initial sizes of the population of interest and of the reference population.

Relative quantification can be used for analyzing the expression of a gene of interest during the development of an organism. In order to correct in particular for variations in quantity and in quality between samples taken from the organism at different times, in addition to analyzing the target gene of interest, a reference gene is also analyzed that is known for having a level of expression that remains stable during development.

A final step then consists in comparing the ratios

$$\frac{{N}_{0 target}}{{N}_{0 ref}}$$

between the various samples that have been taken.

In order to achieve the desired results, two strategies are possible.

The prior art strategy is based on detecting the threshold cycle Ct and it normally takes place as follows. For each sample taken at different instants tO, t1, t2, . . . , tn, the ratio

$$\frac{{N}_{0 target}}{{N}_{0 ref}}$$

is determined, making use of at least one standard (i.e. a standard for which N_{0target} and N_{0ref} are known), which amounts to performing two successive absolute quantifications followed by calculating a ratio.

Another strategy that is particularly advantageous in the context of the invention consists in determining for each sample taken at different instants t0, t1, t2, . . . , tn the ratio:

$$\frac{{( \frac{{N}_{0 target}}{{N}_{0 ref}} )}_{sample}}{{( \frac{{N}_{0 target}}{{N}_{0 ref}} )}_{sample\_t0}}$$

directly by using the following formula:

$$\frac{{( \frac{{N}_{0 target}}{{N}_{0 ref}} )}_{sample}}{{( \frac{{N}_{0 target}}{{N}_{0 ref}} )}_{sample\_t0}} = \frac{{( {F}_{0 target} )}_{sample}}{\frac{{( {F}_{0 target} )}_{sample\_t0}}{\frac{{( {F}_{0 ref} )}_{sample}}{{( {F}_{0 ref} )}_{sample\_t0}}}}$$

In this second implementation, which in the end makes use only of the parameter F₀, in combination with the technique of the invention, no standard sample is needed, which is particularly advantageous.

Reference is now made to FIG. 10 which shows an installation for implementing the method of the invention. It comprises a support SUPP in this case comprising a well containing the sample of interest ECH and a well containing a standard sample referenced St, for example. The support SUPP is enclosed in an enclosure ENC, e.g. fitted with heater means (not shown) for applying a PCR reaction to the standard and to the sample of interest.

In the example described, provision is preferably made to take measurements of the quantities of fluorescence emitted on each cycle, both by the standard St and by the sample of interest ECH. To this end, a selected reagent is inserted into the wells and the samples are illuminated by a lamp (e.g. a halogen-tungsten lamp) in order to measure the respective quantities of fluorescence coming from the sample of interest and from the standard sample on each PCR cycle that is applied. In addition, an apparatus for detecting fluorescence comprises, for example, an objective lens 11 for collecting the light coming from the fluorescence, and photon counting means 10, e.g. a charge-coupled device (CCD) camera, and/or photomultipliers, in order to measure the fluorescence emitted on each PCR cycle from the sample of interest and from the standard. Thus, the fluorescence emitted by each well is advantageously focused by the lens 11 and then is preferably detected by a CCD camera 10 connected to an acquisition card 21, e.g. of the Personal Computer Memory Card International Association (PCMCIA) type provided in a central unit 20 of a computer.

The computer is then connected to the above-mentioned measuring means 10 to receive therefrom signals that are representative of the measured quantities of fluorescence detected on each PCR cycle, and to process these signals in order to determine an initial size for the population of interest prior to the first cycle, by implementing the method of the invention.

Typically, the processor unit comprises the following:
an acquisition card 21 connected to the measurement means 10;
working memory 25 (e.g. of the random access memory (RAM) type) for temporary storage and processing of the above-mentioned signals;
permanent memory 24 for storing the computer program product in the meaning of the invention and for storing the data that has been processed and that is ready for use, e.g. in subsequent diagnosis;
where appropriate, a reader 22 of a memory medium such as a CD-ROM, for example, which may initially carry the computer program product;
optionally a communications interface 26 for communicating with a local or remote site (connection 28), e.g. for transmitting the processed data so as to enable a diagnosis to be made remotely concerning a patient;
a graphics interface 27 typically connected to a display screen 30; and
a processor 23 for managing the interactions between these various items of equipment.

The computer may also have input members such as a keyboard 41 and/or a mouse 42 connected to the central unit 20.

Nevertheless, it should be understood that in the meaning of the invention the installation comprises overall:
a sample support SUPP, at least for the sample of interest;
a first apparatus ENC for applying said succession of amplification reactions at least to the population of interest in the sample of interest;
a second apparatus 10 for taking measurements representative of the current size of the population of interest; and
computer means 20 suitable for receiving measurement signals from the second apparatus 10 and for implementing all or some of the steps of the method of the invention.

For this purpose, a computer program product can be used for controlling the computer means. The program may be stored in a memory of the processor unit 20 or on a removable memory medium (CD-ROM etc.) and suitable for co-operating with the reader of the processor unit. The computer program in the meaning of the invention then contains instructions for implementing all or some of the steps of the method of the invention. For example, the algorithm of the program may be represented by a flow chart equivalent to the diagram of FIG. 9.

1. A method implemented by computer means to quantify, in absolute and/or relative manner, an initial population of nucleic acids in a sample of interest subjected to a succession of applications of a population amplification reaction, during which experimental measurements are taken representative of a current size of the population of at least the sample of interest,
the method comprising the following steps:
a) providing a model of the yield of the amplification reaction as a function of the succession of amplifications, said model comprising:
a substantially constant stage for a first portion of the applications of the amplification reaction; and
a non-constant stage for a second portion of the applications of the amplification reaction;
the first and second portions being united by a changeover region in which yield changes over between the constant and non-constant stages, said region having an amplification index corresponding substantially to the changeover;
b) using the yield model to express a relationship involving at least the changeover index and a parameter representative of the initial population size in the sample of interest;
c) determining at least the changeover index by comparison with the experimental measurements; and, in a subsequent or immediately following step d) deducing therefrom the initial population size in the sample of interest.

2. A method according to claim 1, including:
in step b), using the yield model to express a variation that is parameterized as a function of said succession of amplifications, involving at least one parameter representing the changeover index; and
in step c), determining at least said parameter representing the changeover index by comparison with said experimental measurements.

3. A method according to claim 2, wherein said parameterized variation is representative of the current population size in the sample of interest,
wherein said variation further involves a parameter representative of the initial population size in the sample of interest; and
wherein in steps c) and d), the parameters representative of said amplification index and of the initial population size in the sample of interest are determined substantially together.

4. A method according to claim 2, wherein said parameterized variation is representative of the yield, and wherein in step c), an experimental variation of the yield is determined from said experimental measurements, in order to compare the parameterized variation with the experimental variation.

5. A method according to claim 4, including, in step d):
d1) determining a second parameterized variation that is representative of the current population size in the sample of interest, and that involves at least the parameter representing said amplification index, and a parameter representative of the initial population size in the sample of interest;
d2) applying a parameterized value for the index as determined in step c) to the second variation; and
d3) adjusting at least the parameter representative of the initial population size by direct comparison of the second variation with the experimental measurements.

6. A method according claim 5, including:
in step d2), applying a coarse value for the index, whereas
in step d3), refining the value of the index while also adjusting the parameter representative of the initial population size.

7. A method according to claim 3, wherein said parameterized variation or said second parameterized variation, as the case may be:
is representative of said experimental measurements; and
includes a parameter corresponding to a measured value representative of the initial population size,
and wherein the measurement value of the initial population size is determined by comparing said parameterized variations with the experimental measurements.

8. A method according to claim 1, including applying a prior step of processing the experimental measurements, which step comprises subtracting a background noise from the measurements and introducing a compensation to take account of a non-zero measurement representative of the initial population size.

9. A method according to claim 7, including obtaining a measurement value for an initial population size in a standard sample having a known initial population size and deriving a proportionality relationship therebetween; and determining the value of the initial population size in the sample of interest by applying the same proportionality relationship between the initial population size and its measurement to the sample of interest.

10. A method according to claim 7, including obtaining respective measurement values for the initial population sizes in standard samples having known initial population sizes, and by:
establishing a dependency relationship between the initial population sizes of the standard samples and the corresponding measurement values for their respective initial population sizes; and
after determining the measurement value for the initial population size of the sample of interest, determining the initial size of the population of interest by interpolation on said dependency relationship.

11. A method according to claim 9, including providing one or more standard samples having respective known initial population sizes, applying said succession of amplifications to said standard samples under substantially the same conditions as for the sample of interest, and determining their effective initial measurement values by comparing the parameterized variations with the experimental values.

12. A method according to claim 3, including providing a plurality of standard samples having respective known initial population sizes, applying said succession of amplifications thereto under substantially the same conditions as for the sample of interest, and determining their respective indices in application of steps a), b), and c), and by, in step d):
establishing a dependency relationship between the initial population sizes of the standard samples and their indices; and
after determining the index for the sample of interest, determining the initial size of the population of interest by interpolation on said dependency relationship.

13. A method according to claim 1, wherein, for a relative quantification, providing not only the population of interest, but also a reference population that is subjected to a succession of applications of the amplification reaction, the method consists in taking, respectively:
experimental measurements representative of the size of the population of interest; and
experimental measurements representative of the size of the reference population;
the method continuing by applying steps a), b), and c) to the reference population, with step d) consisting in determining a ratio between the respective initial sizes of the population of interest and of the reference population.

14. A method according to claim 1, including:
expressing the experimental measurements in the form of an experimental variation of yield as a function of said succession of amplifications; and
obtaining an experimental variation of yield as a function of said succession of amplifications comprising:
a first region that is substantially subject to noise for low amplification index numbers; and
followed by a second region with less noise for higher amplification index numbers.

15. A method according to claim 14, in which said non-constant stage of the yield is one of decreasing yield, the method including:
estimating a coarse value for the constant stage of yield; and
at least when seeking the index in said changeover region, ignoring at least some of the measurements in said less noisy second region for which the estimated yield is below a threshold value, preferably below a fraction of the constant stage.

16. A method according to claim 14, in which said non-constant stage of the yield is a stage of decreasing yield, the method including identifying said changeover region by working in the direction of decreasing amplification index number starting from said less noisy second region, and detecting a coarse amplification index at which the yield perceptibly exceeds a predetermined value (E₀=1).

17. A method according to claim 16, wherein the estimated value of said amplification index in the changeover region is refined, possibly to obtain a fractional value, by working in the direction of increasing amplification index number starting from the coarse index, by detecting an amplification index for which the yield is approximately equal to said predetermined value (E₀=1).

18. A method according to claim 1, including modeling said non-constant stage of the yield by a decreasing exponential including a decrease parameter, and determining said decrease parameter in step c) with the index in the changeover region by comparison with the experimental measurements.

19. A method according to claim 1, in which the amplification reaction is a polymerase chain reaction performed in real time.

20. A method according to claim 1, in which said measurements are measured quantities of emitted fluorescence.

21. An installation for implementing the method according to claim 1, the installation comprising:
a sample support for supporting at least the sample of interest;
a first apparatus for applying said succession of amplification reactions, at least to the population of interest in the sample of interest;
a second apparatus for taking measurements representative of the current size of the population of interest; and
computer means suitable for receiving measurement signals from the second apparatus and implementing the method according to claim 1.

22. A computer program product for storing in a memory of a processor unit or on a removable memory medium suitable for co-operating with a reader of said processor unit, the program product comprising instructions for implementing the method according to claim 1.
